(19) United States
(12) Patent Application Publication
(10) Pub. No.: US 2013/0124373 A1
(43) Pub. Date: May 16, 2013

(54) SYSTEM AND METHOD FOR DEVELOPING, SELLING AND DELIVERING SOFTWARE APPLICATIONS FOR REAL ESTATE MULTIPLE LISTING SERVICES

(71) Applicants: MICHAEL JAMES WURZER, FARGO, ND (US); GREG ROGER KILWEIN, FARGO, ND (US)

(72) Inventors: MICHAEL JAMES WURZER, FARGO, ND (US); GREG ROGER KILWEIN, FARGO, ND (US)

(73) Assignee: FINANCIAL BUSINESS SYSTEMS, INC., FARGO, ND (US)

(21) Appl. No.: 13/672,342

(22) Filed: Nov. 8, 2012

Related U.S. Application Data
(60) Provisional application No. 61/558,951, filed on Nov. 11, 2011.

(51) Int. Cl. G06Q 30/06

(52) U.S. Cl. CPC G06Q 30/0641
USPC 705/27.1

(57) ABSTRACT

A method for developing, selling and delivering software applications for real estate multiple listing services (MLS), brokers, agents, companies, franchises, and consumers.

### PRIORITY CLAIM

This application claims priority to U.S. Provisional Patent Application Ser. No. 61/558,951, filed Nov. 11, 2011, which is hereby incorporated by reference in its entirety as if fully set forth herein.

### BACKGROUND OF THE INVENTION

Software development, sales, and delivery in the MLS industry today are inefficient because there is no common platform, thereby limiting both the number of developers and/or potential users of any one software application.

There are approximately 800 MLS organizations in the United States today. Each MLS essentially is a separate market for real estate software, because each has its own data formats, business rules, and requirements for accessing the MLS data and selling software to MLS members (brokers, agents, appraisers, and others). Because of these obstacles, typically each MLS is served by one MLS software vendor and the brokers and agents in that MLS have little or no choice in the software system provided. Choice is further restricted in the MLS software system because changing MLS systems is a major undertaking given the diverse data sets and business rules.

Further limiting the size of the MLS software market, consumers (home buyers and sellers) are not part of the market at all even though they are one of the primary (if not ultimate) consumers of MLS data. Instead, consumers typically are served by non-MLS consumer real estate web sites, which attempt to aggregate and replicate the MLS database either from a data feed from each MLS or through syndicated data from directly from brokers. This data replication and syndication results in licensing and compliance inefficiencies for the MLS, as the data is no longer in the MLS's direct control. Lastly, reliance on non-MLS software and web sites to serve consumers makes those sites the primary source of contact and information for consumers instead of the MLS and their broker and agent members.

The result of these inefficiencies is that the market for MLS software is much smaller than it could be, the applications developed are not interoperable, and brokers and agents are less able to serve their buyer and seller customers.

### BRIEF DESCRIPTION OF THE DRAWING

Preferred and alternative examples of the present invention are described in detail below with reference to the following drawings:

FIG. 1 is a screenshot of the FlexMLS App Bar and App Store;

FIG. 2 is a screenshot of the FlexMLS Dashboard;

FIGS. 3A and 3B are screenshots of the FlexMLS App Store Home and Search Pages;

FIGS. 4A and 4B are screenshots of the FlexMLS Store Detail and MLS System;

FIG. 5 is a screenshot of the Developer Offered CMA Application;

FIG. 6 is a screenshot of the diagrams outlining the inefficiencies in the current MLS software market;

FIG. 7 is a screenshot of the FlexMLS Platform; and

FIG. 8 is a screenshot of the FlexMLS API.

FIGS. 9-17 illustrate screenshots according to an embodiment of the invention.

### DETAILED DESCRIPTION OF THE PREFERRED EMBODIMENT

Embodiments of the invention may be operational with numerous general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

Embodiments of the invention may be described in the general context of computer-executable instructions, such as program modules, being executed by a computer and/or by computer-readable media on which such instructions or modules can be stored. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

Embodiments of the invention may include or be implemented in a variety of computer readable media. Computer readable media can be any available media that can be accessed by a computer and includes both volatile and nonvolatile media, removable and non-removable media. By way of example, and not limitation, computer readable media may comprise computer storage media and communication media. Computer storage media include volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

According to one or more embodiments, the combination of software or computer-executable instructions with a computer-readable medium results in the creation of a machine or apparatus. Similarly, the execution of software or computer-executable instructions by a processing device results in the creation of a machine or apparatus, which may be distinguishable from the processing device, itself, according to an embodiment.

Correspondingly, it is to be understood that a computer-readable medium is transformed by storing software or computer-executable instructions thereon. Likewise, a processing device is transformed in the course of executing software or computer-executable instructions. Additionally, it is to be understood that a first set of data input to a processing device during, or otherwise in association with, the execution of software or computer-executable instructions by the processing device is transformed into a second set of data as a consequence of such execution. This second data set may subsequently be stored, displayed, or otherwise communicated. Such transformation, alluded to in each of the above examples, may be a consequence of, or otherwise involve, the physical alteration of portions of a computer-readable medium. Such transformation, alluded to in each of the above examples, may also be a consequence of, or otherwise involve, the physical alteration of, for example, the states of registers and/or counters associated with a processing device during execution of software or computer-executable instructions by the processing device.

As used herein, a process that is performed “automatically” may mean that the process is performed as a result of machine-executed instructions and does not, other than the establishment of user preferences, require manual effort.

The Flexmls Platform solves the above inefficiencies with three main components :

1. Flexmls API—The Flexmls API provides software developers with a single API for accessing the data from multiple MLS systems in a standard format real-time without having to replicate the data on their own servers. The API provides single sign-on authentication and automatically enforces role-based permissions to ensure that the business rules of the MLS are enforced without relying on software developer compliance with license restrictions.

2. MLS App Store—The MLS App Store provides a central site for software developers to advertise their applications and provides MLSs, brokers, agents with a site to learn about, rate, comment on, and purchase those software applications. The App Store can handle all payment collection and revenue sharing agreements for all MLSs and developers, as well as provide reporting and administrative functionality for processing those payments and distributions.

3. Flexmls App Bar—The Flexmls App Bar is the web-based delivery mechanism for the applications and the MLS App Store itself. This App Bar is web software that can either frame or be framed by other web sites, including MLS systems and consumer-facing MLS, broker and agent web sites.

The flexmls App Bar is intended to act as an application manager tool. For sites requiring user authentication, the Single Sign On component of the flexmls App Bar can authenticate the user and display the App Bar once successfully authenticated. Once authenticated, the user never needs to log in to applications managed by the flexmls App Bar since the flexmls App Bar provides Single Sign On (SSO). SSO provides a way for applications managed by the flexmls App Bar to identify that the user has already been authenticated, allowing applications to bypass their usual authentication process, without ever transferring the user's user name or password to the applications within the flexmls App Bar. For sites that do not require authentication, the flexmls App Bar can act as an application manager without the additional SSO features.

To install the flexmls App Bar in an MLS system, the MLS vendor can replace their authentication process with the one provided by the flexmls App Bar. Once the user has successfully authenticated the flexmls App Bar can display and show the applications that the user has configured to show, which by default can include their MLS system. The flexmls App Bar can frame applications that run within it and can offer an embedding option for MLS systems that are not compatible with frames. The embedding option can require the MLS to add a line of code which can then make the App Bar appear at the top of the page.

The App Bar also can be used on other sites, such as MLS, broker and agent sites serving consumers. By allowing the Flexmls App Bar to be used in conjunction with other web sites, the App Bar provides a method for extending the functionality of those sites with the software available through the App Store. This allows MLS′ to provide more software to their members directly within their existing MLS system and also allows brokers and agents to deliver more software to consumers and their customers.

The App Bar also acts as a client for the Flexmls API, thereby making API functionality readily available for use by the MLS, broker, agent and other sites using the Flexmls Platform. For example, a consumer-facing MLS, broker or agent site using the App Bar can retrieve and submit contact information (such as customer information, favorite listings, saved searches, etc.) through the Flexmls API by calling functionality provided by the App Bar.

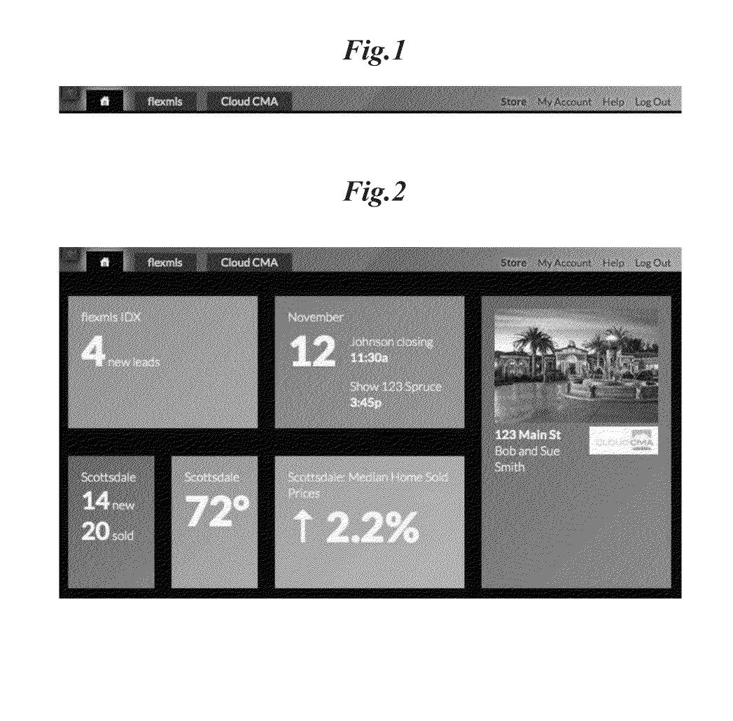

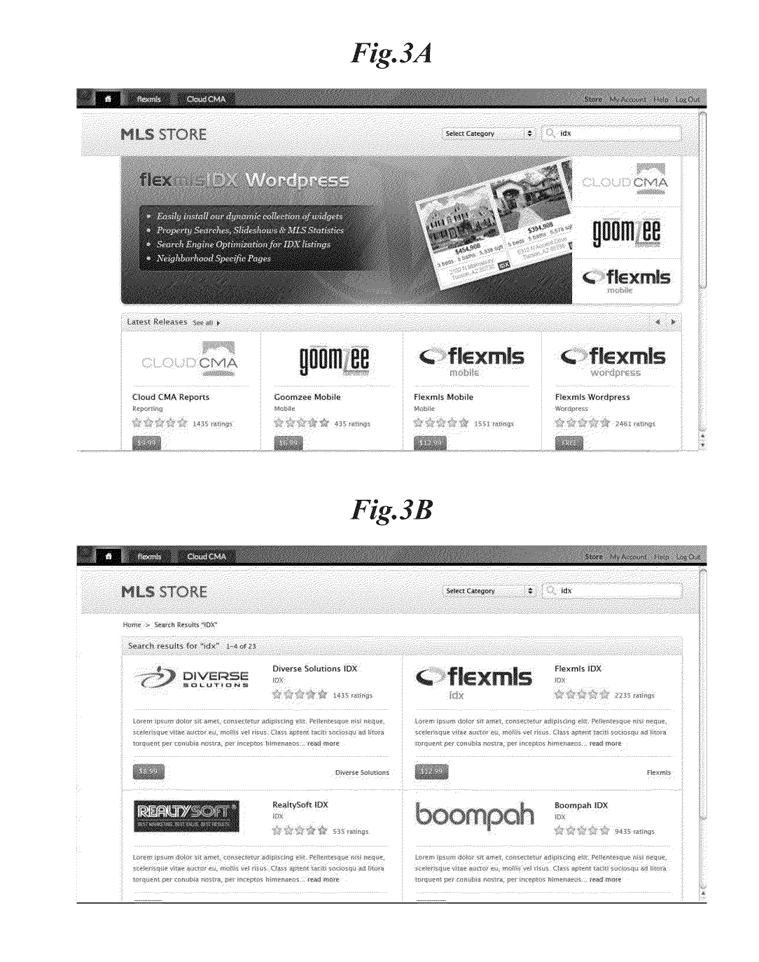

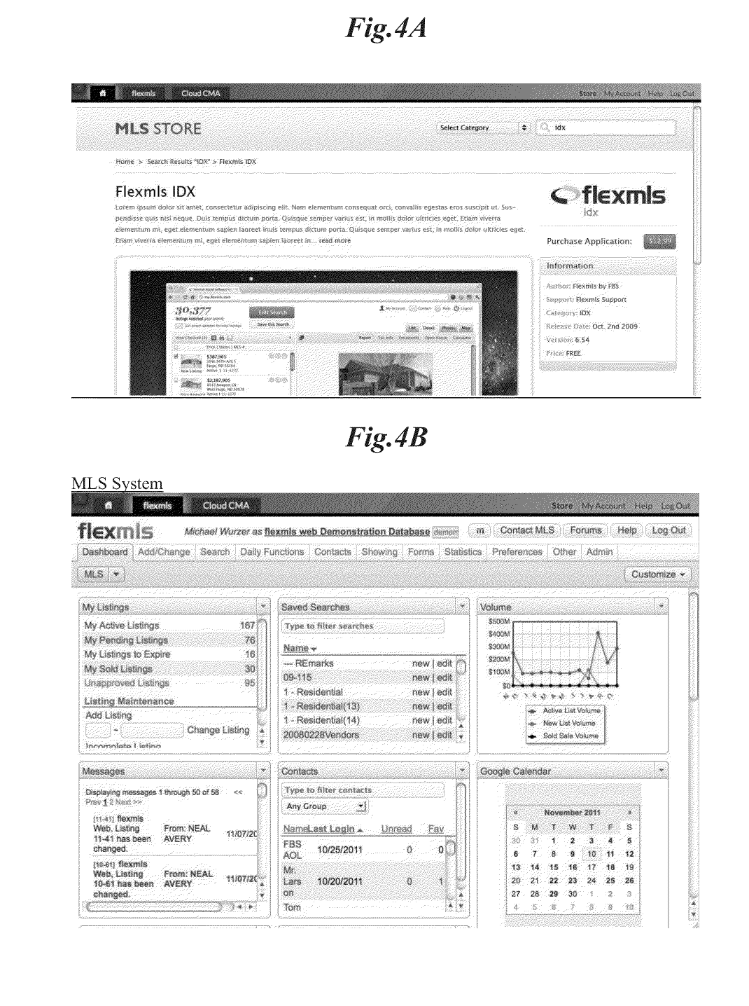

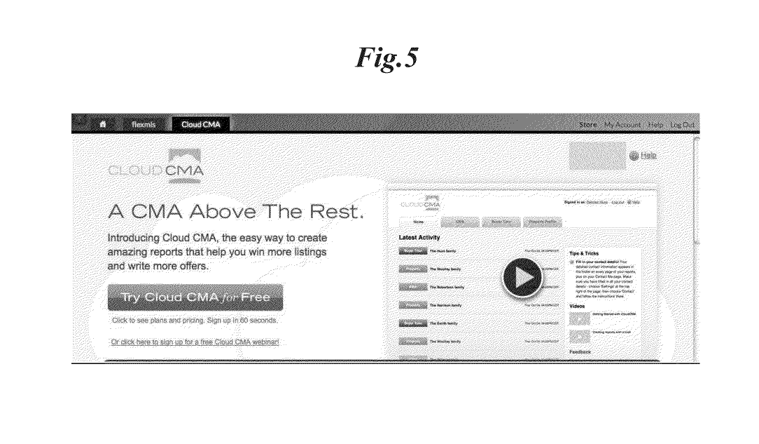

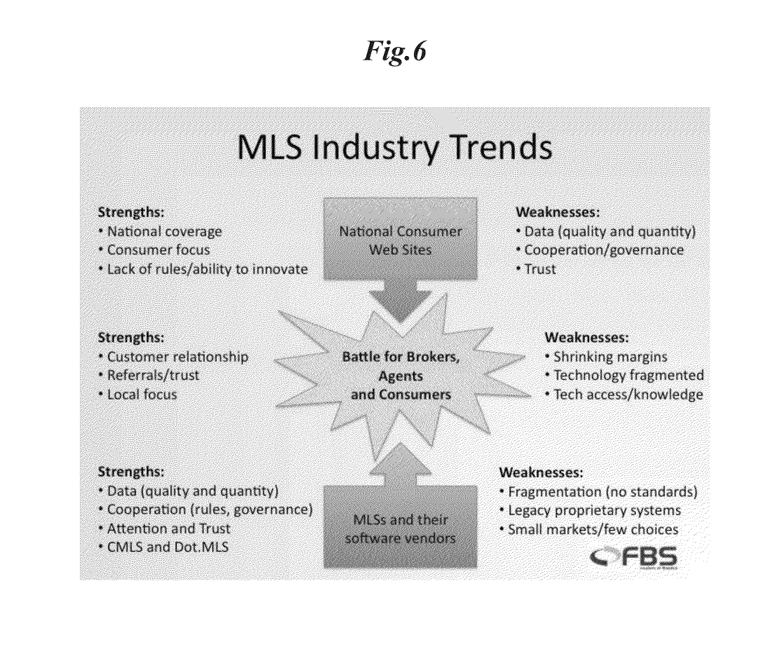

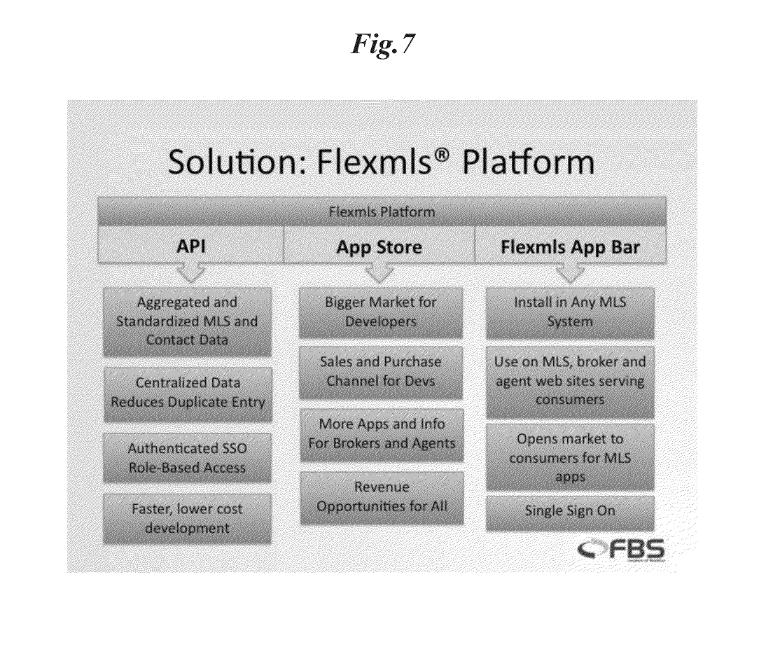

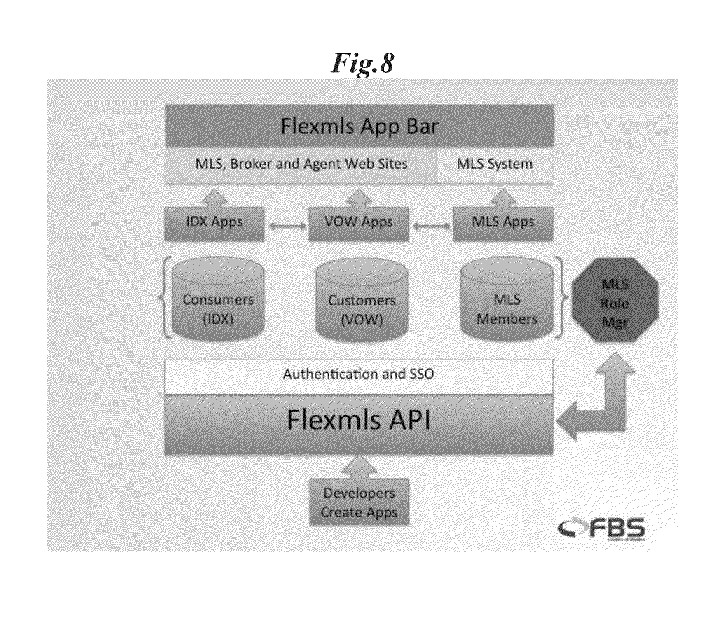

FIG. 1 depicts the Flexmls App Bar by itself Some components of the App Bar are:

Home Button/Dashboard. The “home” button shows the app dashboard, which contains widgets with information delivered live from each of the applications the user has installed and also serves as a navigation option for those applications. A screen shot of a sample dashboard is set out in FIG. 2, for example.

Application Tabs. Each application purchased and installed by the user can be pinned to the app bar as a tab to allow the user easy access to that application. In the image above, the two application tabs are flexmls (an MLS system) and Cloud CMA (a third party CMA software). The user can have as many applications tabs as they like.

Store. The App Bar also includes a link to the App Store, which allows the user to research, review, rate and purchase available applications in the store.

My Account. The My Account link allows the user to review and manage their purchases and subscriptions to software applications.

Help. The Help link allows the user to access help for the App Bar and Store.

Log Out. The Log Out link allows the user to log out of the App Bar and all related applications at once.

Collapse/Expand. On the far left is an option to collapse and expand the App Bar so that it does not interfere with the application currently being used.

The image in FIG. 1 depicts the App Bar installed inside an MLS system, but, importantly, the App Bar also can be installed on a consumer-facing web site from the MLS, brokers or agents. In that case, the App Bar will ensure the consumer only has access to applications and information for which they have permission and will provide a mechanism for the site owner to offer a variety of those applications to their site visitors.

An embodiment makes it easier for software developers to create software using the MLS data by providing an API that implements the MLS business rules based on the end user roles or permissions. To do this, the API manager allows them to define user roles (role manager), field permissions (field manager), and map fields (field mapper) to the RESO data dictionary. Screen shots of those functions are as follows:

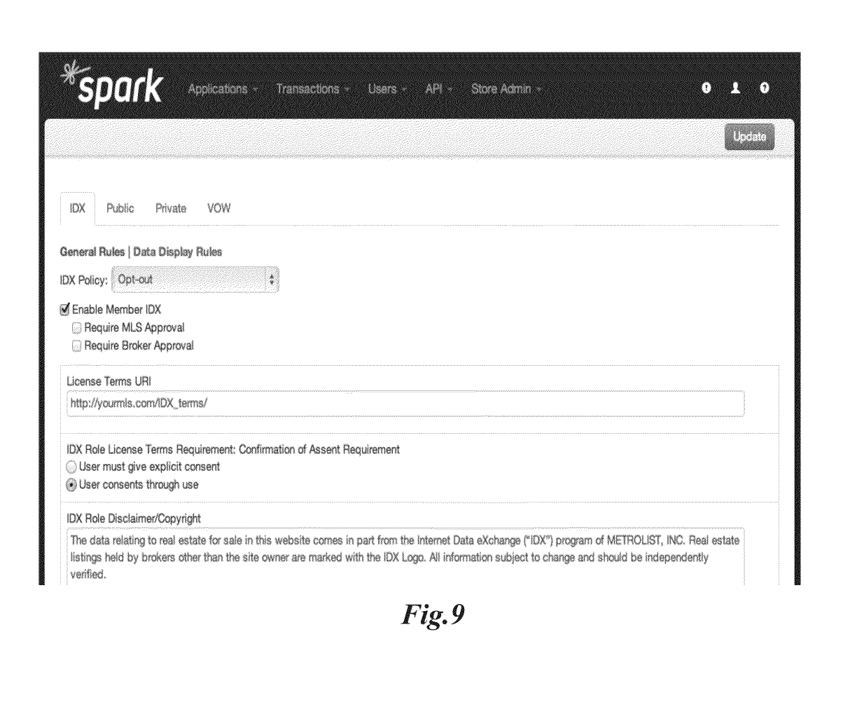

Role Manager is illustrated in FIG. 9.

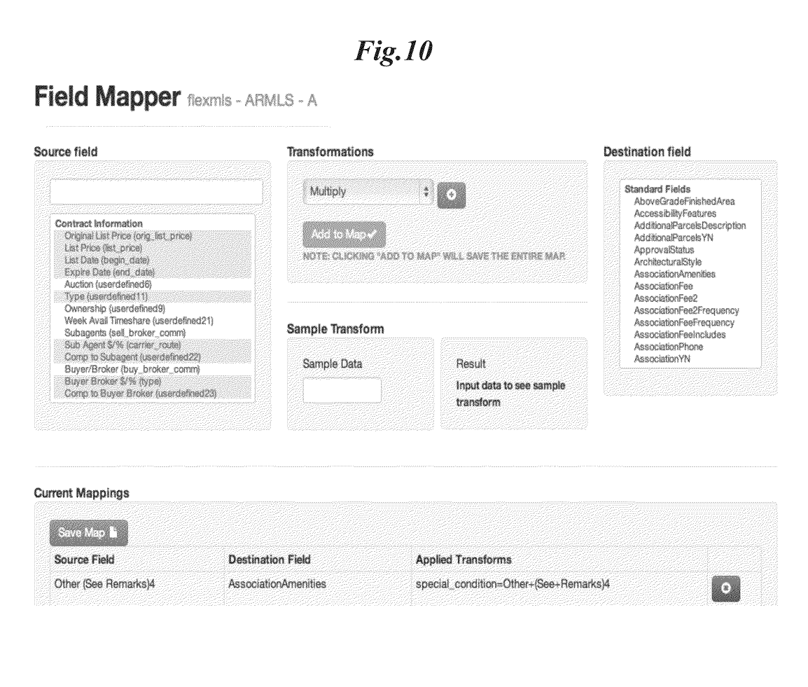

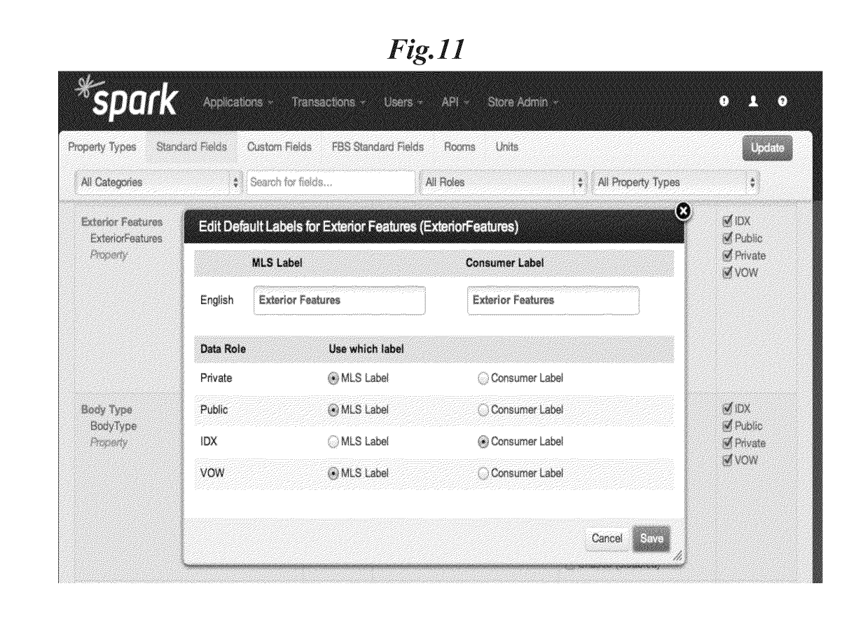

Field Mapper is illustrated in FIG. 10.

Field Manager is illustrated in FIG. 11.

All of the above functions help the MLS define the rules and roles for the API, which is what developers use to access the MLS data and create the applications for sale in the store.

The store is how MLSs make the applications created using the API available to brokers and agents. Each MLS controls, through the Spark Store Admin functions, which applications are available to their members. In addition the store tracks all the purchases and license agreements documenting those purchases and rights to access and use the MLS information.

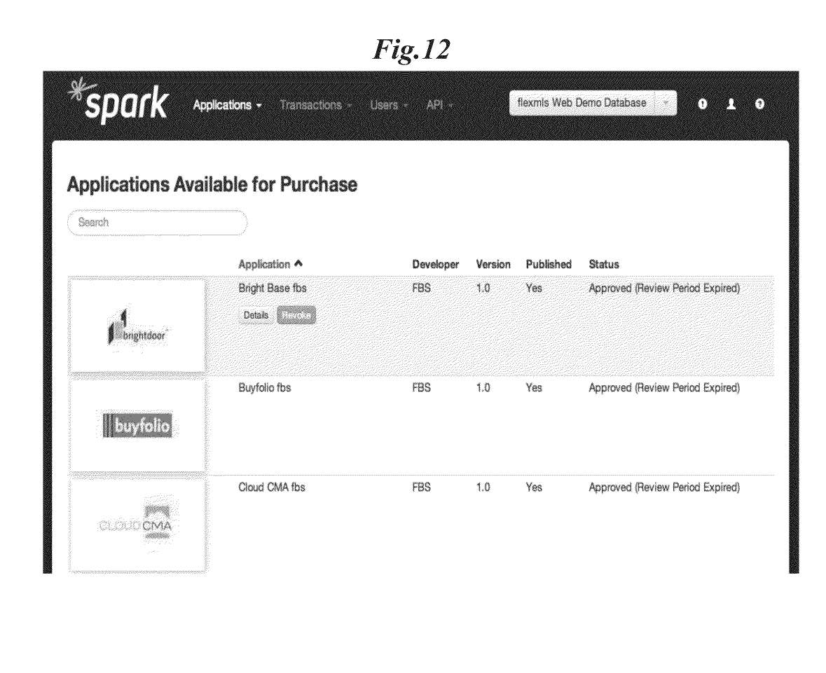

FIG. 12 is a screen shot of where the MLS can revoke an application from their store.

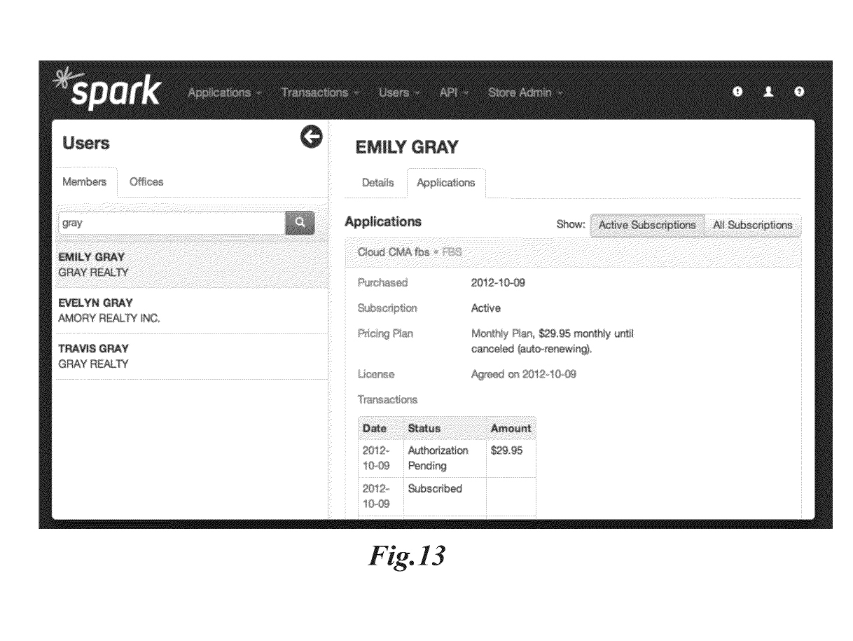

As illustrated in FIG. 13, the MLS can look up a particular user and see what applications they purchased, the license terms, and other details.

The brokers and agents access the store and applications through the App Bar.

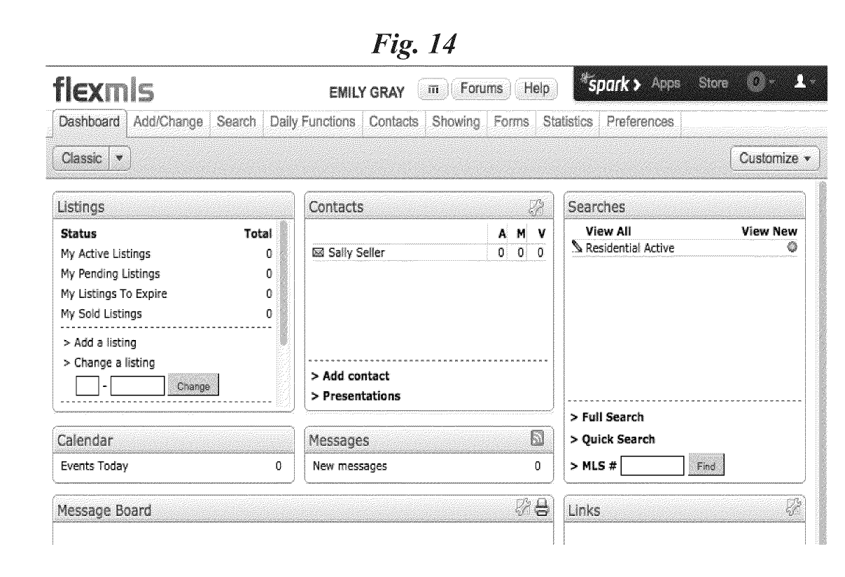

FIG. 14 is a screen shot of the app bar as integrated into Flexmls. This app bar also can be integrated into other non-Flexmls) web sites as well.

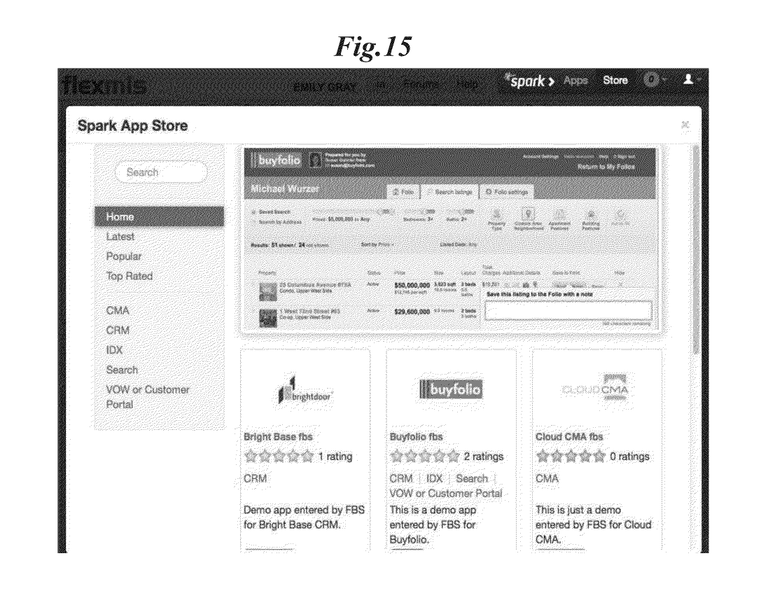

Brokers, agents and other MLS subscribers access the app store through the app bar. The store is illustrated in FIG. 15.

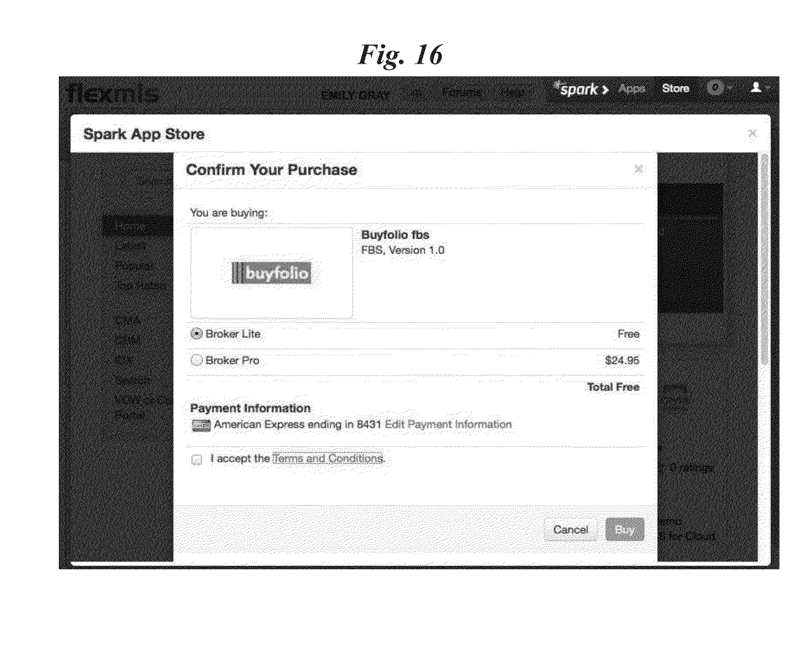

When they find an application they'd like to purchase, they buy it using a screen as illustrated in FIG. 16.

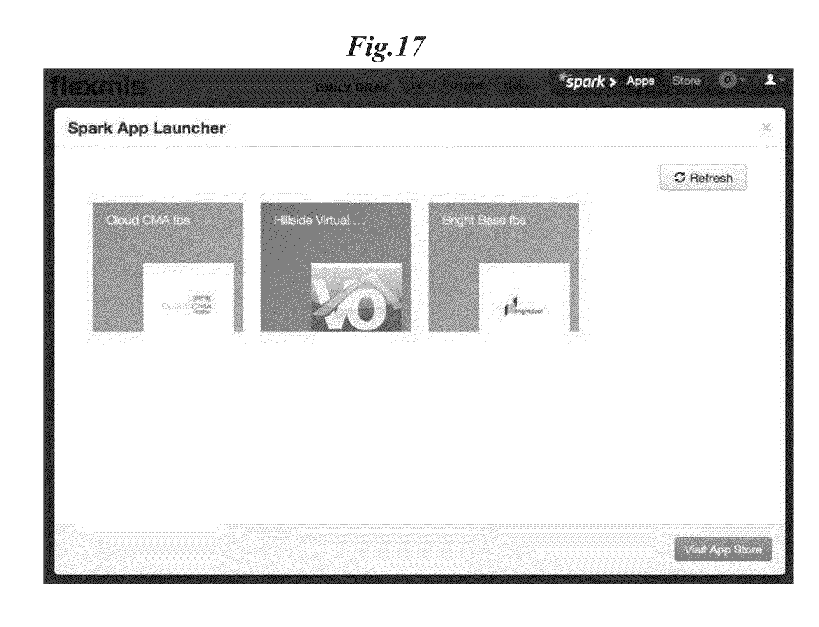

Purchased applications will then show up on the app bar launcher screen as illustrated in FIG. 17.

The integration of the app bar into the MLS system provides for potentially deeper integration directly into the MLS system and so more adoption and usage of those applications.

The Apps service, according to an embodiment, is designed to allow access to a list of applications that the current user has purchased through the Spark store. This service can be used for integrating purchased applications into existing systems, primarily MLS systems.

Data about Purchased Applications

The service will return the following data about each application that the user has purchased.

1. Last updated timestamp—the last time any item in the applications list has changed.

2. Application list—an array of the following:

Product Name

Company Name

Version

Description

Support type and contact info (Support URI, Hours, Email, and Phone)

App categories (CMA, CRM, Forms, Maps, Stats, etc.)

URIs to the application icon in multiple sizes (exact sizes TBD)

Launch URI

App launch categories—an array of zero or more records showing that the application may optionally be launched with any of the following:

1. Launch category—one of the following (note that IDs refer to Spark API IDs):

Listing IDs

Listing search (using the standard Spark API filter syntax)

Saved search IDs

Listing cart Ms

Contact IDs

Contact search (using the standard Spark API filter syntax)

2. Launch category quantity: either single or multiple, indicating whether the application is best launched with only one item of a certain type (single) or may be launched with more than one item (multiple). For example, a CMA app may be best launched with only a single listing, whereas a report printing application could be launched with multiple listings with good results.

Service Details

GET /v1/apps

Returns either:

1. The timestamp that the list of applications was last modified (default when no_expand parameter is supplied); or

2. A paginated list of all applications that the current user has purchased, when_expand=apps is specified). The standard Spark API filter syntax is supported to filter on launch category (listing ID, contact ID, etc.) and category quantity (single or multiple).

```
POST, PUT, and DELETE on /vl/apps is not supported.
Sample Response: no __expand parameter
{
  “D”: {
    “Success”: true,
    “Results”: [ ],
    “LastModifed”: “2010-11 -22T20:09:37Z”
  }
}
Sample Response: _expand=apps
{
  “D”: {
    “Success”: true,
    “Results”: [
      {
        “ProductName”: “Cloud CMA”,
        “CompanyName”: “WR Studios”,
        “Version”: “3.7”,
        “Description”: “Cloud CMA is ..... ”,
        “SupportedBy”: “Developer”,
        “SupportURI”: “http://cloudcma.com/support,”
        “SupportPhone”: “123-456-7890 ext 123”,
        “SupportEmail”: “suppot@cloudcma.com”,
        “AppCategories”: [“CMA”],
        “LaunchUri.”: “http://cloudcma.com/spark”,
        “LaunchCategories”: [
          {
            “Category”: “ListingId”,
            “Quantity”: “Single”,
          }
        ]
      }
    ],
    “LastModifed”: “2010-11-221720:09:37Z”
  }
}
```

Communicating Launch Options

This section describes how an application is launched with various launch options. If there are no items (listings, searches, etc.) with which to launch an app, the LaunchUri should be opened as-is. If there is at least one item with which to launch an app, the following should be appended to the LaunchUri based on what is being sent:

Category Parameter to append to LaunchUri Example: http://myapp.com/spark as an app's LaunchUri

Listing IDs LaunchListingIds=followed by a comma separated list of listing IDs

http://myapp.com/spark?LaunchListingIds=20060412165917817933000000,20 080917142739989238000000

Listing search LaunchListingSearch=followed by a comma separated list of encodeURIcomponent-equivalent encoded Spark API later syntax strings

http://myapp.com/spark?LaunchListingSearch=TotalBedrooms%20Gt%204

Saved Search IDs LaunchSavedSearchIds=followed by a comma separated list of saved search IDs

http://myapp.com/spark?LaunchSavedSearchIds=200604121659178179330000 00,20080917142739989238000000

Listing Cart IDs LaunchListingCartIds=followed by a comma separated list of listing cart IDs

http://myapp.com/spark?LaunchListingCartIds=2006041216591781793300000 0,20080917142739989238000000

Contact IDs LaunchContactIds=followed by a comma separated list of contact IDs

http://myapp.com/spark?LaunchContactId=20060412165917817933000000,20 080917142739989238000000

Contact search LaunchContactSearch=followed by a comma separated list of encodeURIcomponent-equivalent encoded Spark API filter syntax strings

http://myapp.com/spark?LaunchContactSearch=FirstName%20Eq%20′Bill%25

The application being launched must accept either a GET or POST request. If the launch URI with parameters is longer than the browser can accept (typically around 2,000 characters for IE), then a POST request must be issued. If the launch URI with parameters is shorter than the browser can accept, then a GET request must be issued.

While the particular embodiments have been illustrated and described, other embodiments may include other subject matter. Accordingly, the scope of the invention is not limited by the disclosure of the preferred embodiment. Instead, the invention should be determined entirely by reference to the claims that follow.

What is claimed is:

1. A method according to principles described above herein.

2. A system according to principles described above herein.
